(19) United States
(12) Patent Application Publication
(10) Pub. No.: US 2014/0046870 A1
(43) Pub. Date: Feb. 13, 2014

(54) INFORMATION PROCESSING APPARATUS, INFORMATION PROCESSING METHOD, AND PROGRAM

(71) Applicant: Tetsunoshin Anzai, Tokyo (JP)

(72) Inventor: Tetsunoshin Anzai, Tokyo (JP)

(73) Assignee: Sony Corporation, Tokyo (JP)

(21) Appl. No.: 14/112,514

(22) PCT Filed: Apr. 4, 2012
(86) PCT No.: PCT/JP2012/002349

§ 371 Date: Oct. 17, 2013

(30) Foreign Application Priority Data
Apr. 22, 2011 (JP) 2011-095814

(51) Int. Cl. G06Q 30/02

(52) U.S. Cl. CPC G06Q 30/0282
USPC 705/347

(57) ABSTRACT

To improve reliability of feedback information on service, provided is an information processing apparatus including a communication unit, a storage, and a controller. The communication unit is capable of receiving first use information indicating that a first user has used a first service-providing facility and first feedback information on service of the first service-providing facility, the first feedback information being input in a user terminal and associated with the first use information. The storage is capable of storing the received first use information and first feedback information in association with each other. The controller is capable of executing predetermined information processing for indicating that the stored first feedback information has high reliability.

### TECHNICAL FIELD

The present disclosure relates to an information processing apparatus capable of providing feedback information from a user on shops such as restaurants and facilities, and to an information processing method and a program for the information processing apparatus.

### BACKGROUND ART

From the past, a user who received service from a service provider such as a restaurant have posted, on a predetermined website, feedback information (comment, review, and word of mouth) on the service of the service provider.

On the other hand, an administrator of the website has performed moderation processing for checking whether the posted feedback information contains inappropriate feedback such as slander/defamation and a biased opinion, and has released only feedback information that is considered as appropriate information on the website.

However, in the moderation processing, it is difficult to determine whether the feedback information is slander/defamation or an opinion in a case where the service of the service provider was poor in reality. Therefore, there is a tendency that disadvantageous feedback information for a service provider is all deleted and only advantageous (favorable) feedback information is released. In other words, released feedback information is biased and there arises a problem that information useful to a service user and a service provider is not practically released.

In relation to the moderation processing, Patent Literature 1 below discloses a system in which, based on a writing count at which a specific user writes a message to a bulletin board and a browsing count at which the message of the specific user is browsed, an influence rate to the specific user is calculated and a score given to specific service by the specific user is weighted in accordance with the influence rate.

### CITATION LIST

### [Patent Literature]

[PTL 1]

Japanese Patent Application Laid-open No. 2010-128849

### SUMMARY OF INVENTION

In the technique disclosed in Patent Literature 1, however, the influence rate is calculated based on the writing count and the browsing count, and therefore a user who has not actually used service to be scored obtains a higher influence rate if his/her writing count and browsing count are large. Conversely, the influence rate of a user who has actually used the service becomes lower if his/her writing count and browsing count are small. In other words, there is a possibility that the influence rate of a user who may be incapable of appropriately evaluating service becomes higher and the influence rate of a user who can appropriately evaluate service becomes lower. Therefore, it is difficult to say that a degree of reliability of the scoring is high.

In view of the circumstances as described above, it is desirable to provide an information processing apparatus, an information processing method, and a program that are capable of improving a degree of reliability of feedback information on service.

According to an embodiment of the present disclosure, there is provided an information processing apparatus including a communication unit, a storage, and a controller. The communication unit is capable of receiving first use information indicating that a first user has used a first service-providing facility and first feedback information on service of the first service-providing facility, the first feedback information being input in a user terminal and associated with the first use information. The storage is capable of storing the received first use information and first feedback information in association with each other. The controller is capable of executing predetermined information processing for indicating that the stored first feedback information has high reliability.

With this configuration, the information processing apparatus executes the predetermined information processing in the case where the use information of the user and the feedback information are associated with each other, to thereby improve reliability of the feedback information on service. Here, the “service-providing facility” includes, in addition to shops like a restaurant and a hair salon, all facilities such as a hospital and a hotel that provide users with some service. Further, the “use information” is, for example, payment information or information provided only to a user who has used a service-providing facility. Furthermore, the “predetermined information processing” includes, in addition to processing of adding some information to the first feedback information or modifying the first feedback information, processing of releasing only the first feedback information without releasing on a website other feedback information that is not associated with the use information. For example, the first feedback information may be released with information indicating that it is feedback information of a user who has used service in reality. Further, in the case where the first feedback information has an evaluation score of service, a predetermined weight may be applied to the evaluation score.

The communication unit may be capable of receiving second feedback information on the service, which is not associated with the first use information. In this case, the storage may be capable of storing the received second feedback information. In this case, the controller may be capable of processing the first feedback information so as to be distinguishable from the second feedback information.

With this configuration, the information processing apparatus processes the first feedback information so as to be distinguishable from the second feedback information, which allows the user to easily recognize high reliability of the first feedback information.

The first use information may be payment information that is transmitted from the first service-providing facility and includes first electronic money identification information for identifying an electronic money used by the first user for payment in the first service-providing facility. In this case, the communication unit may execute first communication processing of receiving the payment information and second communication processing of receiving the first feedback information and second electronic money identification information for identifying an electronic money used by a user who has input the first feedback information. In this case, the controller may execute the predetermined information processing in a case where the first electronic money identification information included in the payment information received by the first communication processing coincides with the second electronic money identification information received by the second communication processing.

With this configuration, when the electronic money identification information included in the payment information in the service-providing facility coincides with the electronic money identification information received together with the feedback information, the information processing apparatus can ensure that the user who has transmitted the feedback information is a user of the service-providing facility and improve reliability of the feedback information. The “electronic money identification information” used herein is, for example, a card ID used when payment is made using a non-contact IC card or a terminal (smartphone or mobile phone) in which a non-contact IC chip is incorporated. In other words, after the user makes payment by passing the card or terminal over a reader/writer of the service-providing facility, the payment information is transmitted to the information processing apparatus via the reader/writer. Further, the feedback information may be input in the terminal with which the payment has been made and then transmitted, or may be input in another terminal (PC etc,) that is different from the terminal with which the payment has been made, and then transmitted. In the latter case, the card ID is read out with a reader/writer of another terminal and transmitted together with the feedback information when the feedback information is transmitted.

The user terminal may read out, from an IC tag set in the first service-providing facility, a tag ID for identifying the IC tag and transmit the first feedback information to the information processing apparatus together with the tag ID. In this case, the communication unit may receive the tag ID as the first use information.

With this configuration, the information processing apparatus can ensure, by reception of the tag ID, that the user who has transmitted the feedback information is a user of the service-providing facility.

The storage may store positional information items of a plurality of service-providing facilities including the first service-providing facility. In this case, the communication unit may receive second feedback information on service of a second service-providing facility that is different from the first service-providing facility. In this case, the controller may execute, in a case of determining based on the positional information items that a distance between the first service-providing facility and the second service-providing facility is within a predetermined range, predetermined information processing for indicating that the second feedback information has high reliability.

With this configuration, even if the use of a service-providing facility as a feedback target has not been recorded, in the case where the use of another service-providing facility located near the service-providing facility has been recorded, the information processing apparatus can improve reliability of the feedback information by analogizing that the service-providing facility as a feedback target has also been used in reality.

The communication unit may receive, from the first service-providing facility, reply information with respect to the first feedback information and discount information allowing a discount to be given at a time of payment for service that can be provided later to the first user in the first service-providing facility. In this case, the storage may store the received reply information and discount information. In this case, the controller may control the communication unit to transmit the reply information and information indicating presence of the discount information to the user terminal and to transmit the discount information to one of the user terminal and the first service-providing facility.

With this configuration, the information processing apparatus can notify a user of the reply information with respect to the feedback information and register the discount information in the first service-providing facility or in the user terminal so that discount can be given to future payment. In the case where the discount information is transmitted to the user terminal, the discount information is written in a payment IC chip of the user terminal so that discount can be given to the next payment of the user. Further, in the case where the discount information is transmitted to the first service-providing facility, the discount information is written in a payment terminal of the first service-providing facility so that discount can be given to the next payment of the user.

The payment information may include third electronic money identification information for identifying an electronic money of another user provided with the service in the first service-providing facility, together with the first user who has made the payment. In this case, the controller may execute the predetermined information processing also in a case where the third electronic money identification information coincides with the second electronic money identification information.

With this configuration, in the case where one of a plurality of users makes payment for service provided to them, even if feedback information is transmitted by another user other than the user who has made payment, the information processing apparatus can handle other users in the same way as in the case of the user who has made payment and improve reliability of the feedback information.

The first use information may include information indicating a date and time of usage at which the first user has used the first service-providing facility. In this case, the controller may execute the predetermined information processing in a case where a period of time from the date and time of usage to a date and time at which the first feedback information has been received is within a predetermined period of time.

With this configuration, the information processing apparatus can lower reliability of the feedback information transmitted after a period of time has elapsed since the date and time of usage.

According to another embodiment of the present disclosure, there is provided an information processing method including receiving use information indicating that a user has used a service-providing facility and feedback information on service of the service-providing facility, the feedback information being input in a user terminal and associated with the use information. The received use information and feedback information are stored in association with each other. Then, predetermined information processing for indicating that the stored feedback information has high reliability is executed.

According to still another embodiment of the present disclosure, there is provided a program causing an information processing apparatus to execute a reception step, a storage step, and a release step. In the reception step, use information indicating that a user has used a service-providing facility and feedback information on service of the service-providing facility are received, the feedback information being input in a user terminal and associated with the use information. In the storage step, the received use information and feedback information are stored in association with each other. In the release step, predetermined information processing for indicating that the stored feedback information has high reliability is executed.

As described above, according to the present disclosure, it is possible to improve reliability of feedback information on service.

### BRIEF DESCRIPTION OF DRAWINGS

[FIG. 1]

FIG. 1 is a diagram showing a configuration of a review posting system in a first embodiment of the present disclosure.

[FIG. 2]

FIG. 2 is a diagram showing a hardware configuration of a moderation server according to the first embodiment of the present disclosure.

[FIG. 3]

FIG. 3 is a sequence diagram showing a basic operation flow of the review posting system in the first embodiment of the present disclosure.

[FIG. 4]

FIG. 4 is a sequence diagram showing a moderation processing flow using positional information of a restaurant in the first embodiment of the present disclosure.

[FIG. 5]

FIG. 5 is a diagram showing a relationship between a position of a restaurant and a degree of reliability of review information in the first embodiment of the present disclosure.

[FIG. 6]

FIG. 6 is a sequence diagram showing an example of a processing flow in the case where discount is given alter the moderation processing in the first embodiment of the present disclosure.

[FIG. 7]

FIG. 7 is a sequence diagram showing another example of a processing flow in the case where discount is given after the moderation processing in the first embodiment of the present disclosure.

[FIG. 8]

FIG. 8 is a sequence diagram showing another example of a processing flow in the case where discount is given after the moderation processing in the first embodiment of the present disclosure.

[FIG. 9]

FIG. 9 is a sequence diagram showing a flow of the moderation processing in the case where a representative of a plurality of users makes payment for service provided to them in the first embodiment of the present disclosure.

[FIG. 10]

FIG. 10 is a sequence diagram showing a basic operation flow of a review posting system in a second embodiment of the present disclosure.

[FIG. 11]

FIG. 11 is a sequence diagram showing a basic operation flow of a review posting system in a third embodiment of the present disclosure.

### DESCRIPTION OF EMBODIMENTS

Hereinafter, embodiments of the present disclosure will be described with reference to the drawings.

### First Embodiment

A first embodiment of the present disclosure will first be described.

[General Outline of System]

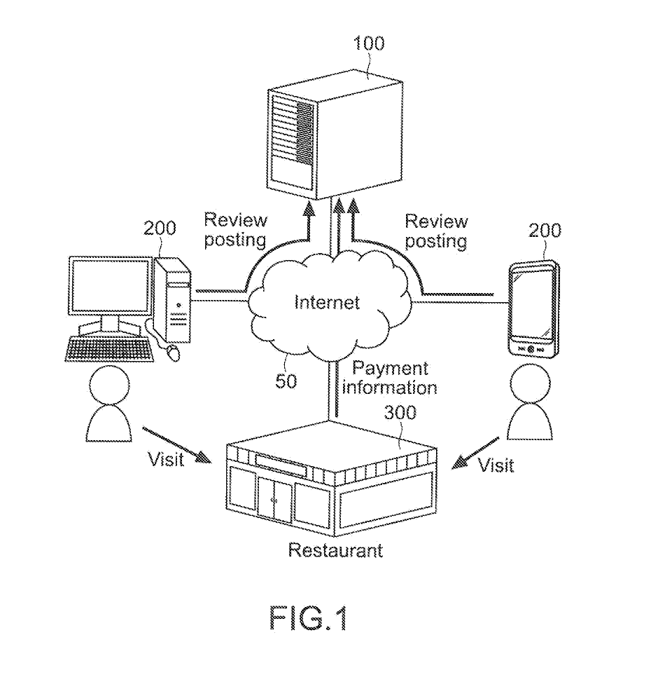

FIG. 1 is a diagram showing a configuration of a review posting system in a first embodiment of the present disclosure. As shown in FIG. 1, this system is constituted of a moderation server 100, user terminals 200, and a restaurant 300.

A user of the user terminal 200 visits the restaurant 300, receives food and beverage service, and makes payment. Immediately or after leaving the restaurant 300, the user uses the user terminal 200 to input a review (feedback information) on the food and beverage service and transmit (post) the review information to the moderation server 100 (or a review posting site managed by the moderation server 100) via the Internet 50. A user who has not visited the restaurant 300 can also post review information to the moderation server 100.

Meanwhile, upon payment of the user described above, the restaurant 300 transmits the payment information to the moderation server 100. The payment is made using an electronic money such as FeliCa (registered trademark) (a card of the user or the user terminal 200 having an electronic money function).

The moderation server 100 performs moderation processing for the posted review information on the basis of the payment information. In other words, the moderation server 100 processes, among posted review information, review information corresponding to the payment information so as to be distinguishable from other review information and then releases the processed review information on the review posting site. In this case, the payment information functions as use is information indicating that the user has used the restaurant, The moderation processing will be described later in detail.

[Hardware Configuration of Moderation Server]

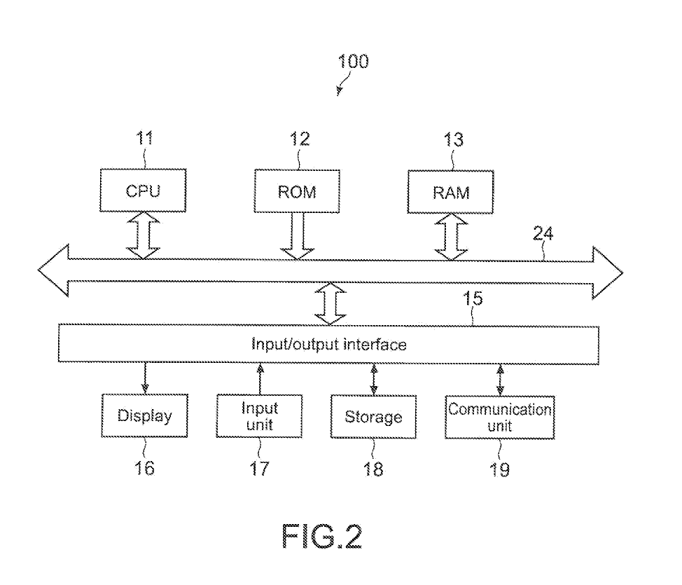

FIG. 2 is a diagram showing a hardware configuration of the moderation server 100 according to the first embodiment of the present disclosure. As shown in FIG. 2, the moderation server 100 includes a CPU (Central Processing Unit) 11, a ROM (Read Only Memory) 12, a RAM (Random Access Memory) 13, an input/output interface 15, and a bus 14 that connects those components to one another.

The CPU 11 accesses the RAM 13 and the like when necessary and performs overall control of the blocks of the moderation server 100 while performing various types of computation processing. The ROM 12 is a nonvolatile memory in which an OS to be executed by the CPU 11, and firmware such as programs and various parameters are fixedly stored. The RAM 13 is used as a work area or the like of the CPU 11 and temporarily stores the OS, various applications in execution, or various pieces of data being processed.

A display 16, an input unit 17, a storage 18, a communication unit 19, and the like are connected to the input/output interface 15.

The display 16 is a display device using, for example, an LCD (Liquid Crystal Display), an OELD (Organic Electroluminescent Display), or a CRT (Cathode Ray Tube). The display 16 may be incorporated into the moderation server 100 or may be externally connected to the moderation server 100.

The input unit 17 is, for example, a pointing device such as a mouse, a keyboard, a touch panel, and other operating apparatus. In the case where the input unit 17 includes a touch panel, that touch panel may be integrated with the display 16.

The storage 18 is a nonvolatile memory such as an HDD (Hard Disk Drive), a flash memory, or other solid-state memory. The storage 18 stores the OS, various applications, and various types of data described above. In particular, in this embodiment, the storage 18 stores a database of user information such as a user name, age, sex, and an e-mail address of each user, restaurant information such as a name and positional information (latitude and longitude information) of each restaurant, review information received from the user terminal 200, payment information received from the restaurant 300, and the like. Further, the storage 18 also stores software such as an application for executing moderation processing in the review posting system.

The communication unit 19 is a NIC (Network Interface Card) and the like for wired connection to the Internet 50 or a LAN (Local Area Network) and performs communication processing between the user terminal 200 and the restaurant 300. For example, the communication unit 19 receives review information from the user terminal 200 and receives payment information from the restaurant 300.

[Operation of System]

Next, an operation of the review posting system configured as described above will be described while focusing on an operation of the moderation server 100. The operation of the moderation server 100 is performed in cooperation with other hardware and software (application) under control of the CPU 11.

(Basic Operation)

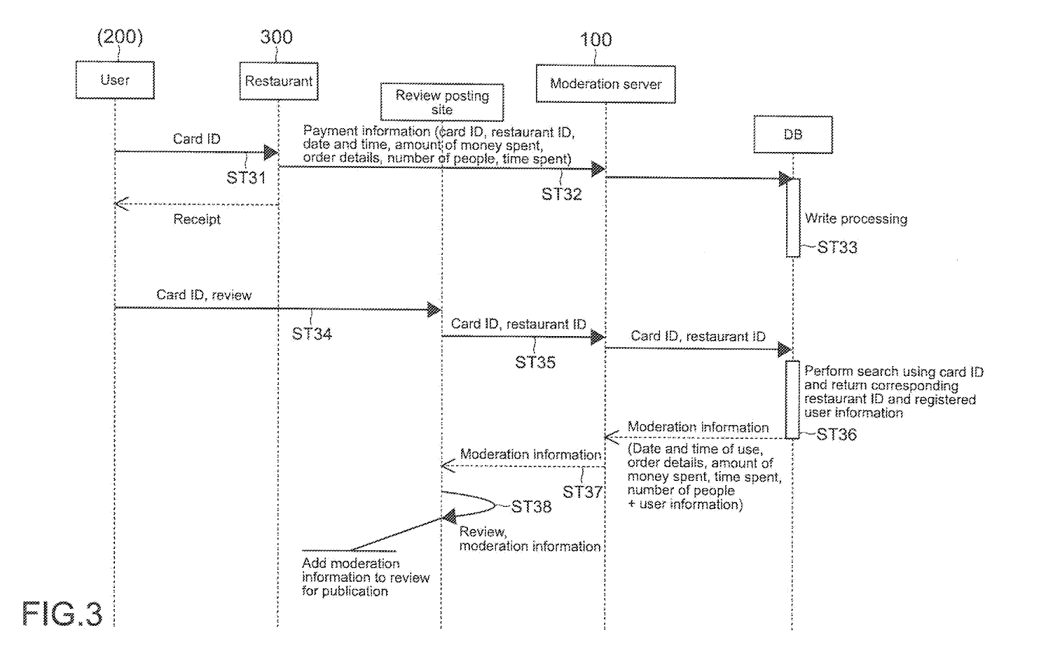

FIG. 3 is a sequence diagram showing a basic operation flow of the review posting system. For convenience of description, the moderation server 100, the review posting site, and a database are separately shown in subsequent figures, but the database and the review posting site may be integrated with the moderation server 100.

As shown in FIG. 3, a user first receives service in the restaurant 300 and makes payment for the service by an electronic money. The payment by the electronic money is performed by passing, for example, an IC card that conforms to the electronic money and a user terminal 200 (mobile phone, smartphone, etc.) in which an electronic money function (IC chip) is incorporated, which are carried by the user, over a reader/writer connected to a POS (Point Of Sale) register installed in the restaurant 300. It is assumed that the reader/writer conforms to communication processing according to NFC (Near Field Communication).

In the IC chip having the electronic money function described above, a card ID that identifies the IC card or the IC chip (that is, identifies the electronic money) is stored.

At the time of payment, the card ID is read out from the IC card or user terminal 200 with use of the reader/writer (Step 31). The POS register of the restaurant 300 (or a communication device connected thereto) transmits payment information including the card ID to the moderation server 100 (Step 32). As payment information other than the card ID, an restaurant ID for identifying the restaurant 300, a date and time of payment, an amount of money spent, order details, the number of people, a time spent, etc. are included.

Upon receiving the payment information, the moderation server 100 writes the payment information into a database while associating information items included in the payment information with one another (Step 33).

After that, the user inputs review information on the service provided in the restaurant 300 to which the payment has been made, with use of the user terminal 200 that has made the payment. The user terminal 200 posts the input review information on a review posting site together with the card ID.

The input and transmission of review information may be performed using a device other than the user terminal 200 that has made the payment. For example, in the case where the user goes home and posts review information from a PC (personal computer), the user passes the IC card or user terminal 200 that has made payment, over a reader/writer incorporated in the PC so that the card ID is read out, and then the user inputs review information.

Further, the input of review information is performed immediately after the payment in some cases. For example, in the case where payment is made using a user terminal 200 that conforms to an electronic money, a reader/writer of the restaurant 300 may push-transmit an URL of a review posting site to the user terminal 200. The user can use the URL for immediately inputting and posting review information. It is assumed that each restaurant 300 has its URL.

Subsequently, the review posting site transmits the card ID and a restaurant ID corresponding to the review posting site (URL) to the moderation server 100 (Step 35). The moderation server 100 searches for a restaurant ID corresponding to the received card ID while using the card ID as a key (Step 36). The presence of a corresponding restaurant ID means that the card ID that has been posted with the review information coincide with a card ID that has been registered in the database at the time of the payment.

In the case where a corresponding restaurant ID is found, the moderation server 100 generates, as moderation information, payment information (date and time of usage, order details, amount of money spent, time spent, number of people) associated with the corresponding restaurant ID and user information (age, sex, etc.) and transmits them to the review posting site (Step 37).

In the review posting site, the moderation information is added to the posted review information and then released (Step 38). The addition of the moderation information to the review information means information processing for indicating that reliability of the review information is high. The moderation information is added in various forms. For example, on the review posting site, the information such as a date and time of use, order details, an amount of money spent, a time spent, and the number of people may be displayed with the review information. By the display of the order details, reliability of a review with respect to a specific menu item is improved.

Further, character information indicating use, like “this user has used this restaurant”, may be merely displayed. Furthermore, instead of the character information, an icon indicating that the user has used the restaurant may be displayed.

In addition, in the case where the review information is one for evaluating the restaurant on the basis of some score (for example, number of stars), score weighting processing may be performed as additional processing for moderation information. In other words, in the case where the review information has a high score, the score may be modified to be a higher score, or conversely in the case where the review information has a low score, the score may be modified to be a lower score.

Further, as the additional processing of the moderation information, review information whose card ID has been registered (that is, review information from user who has actually visited the restaurant), and other review information may be displayed in different areas on the review posting site. Further, a setting may be made with use of a predetermined GUI (Graphical User Interface) such that only the review information whose card ID has been registered is filtered and allowed to be displayed.

(Moderation Processing Using Positional Information of Restaurant)

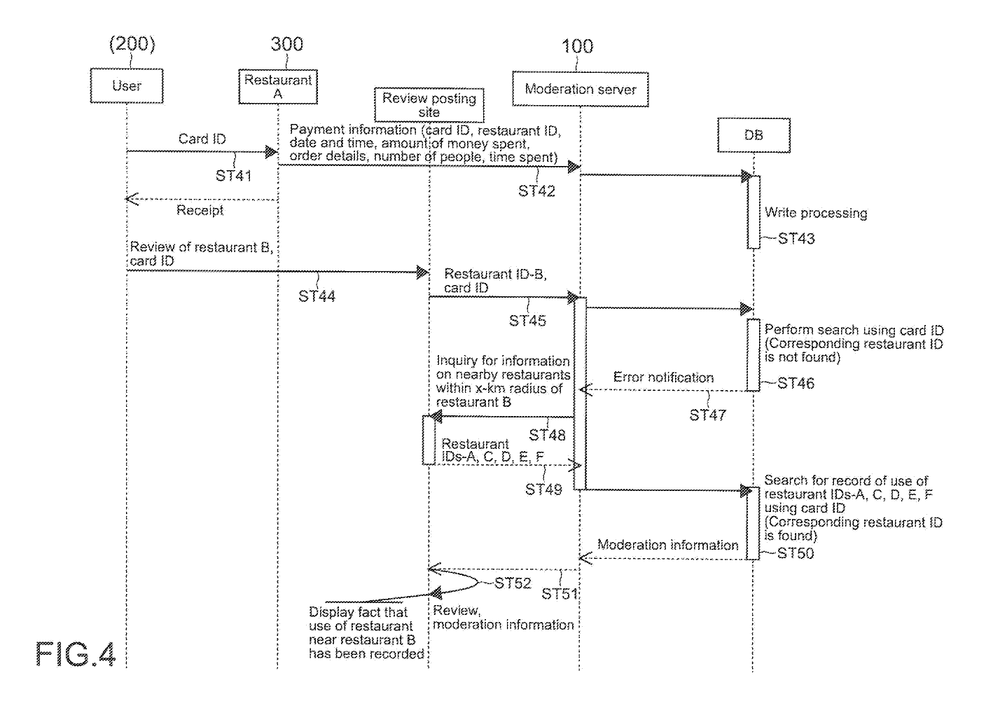

FIG. 4 is a sequence diagram showing a moderation processing flow using positional information of the restaurant 300. In FIG. 3 described above, the moderation information is added to the review information of the restaurant 300 for which payment has been actually made. However, in the processing of FIG. 4, if payment information of a restaurant for which review information has been posted is not registered, and payment information of restaurants near the restaurant is registered, it is considered that there is a high possibility that the restaurant as a review target has also been used. Therefore, the moderation information is added to the review information of the restaurant.

In FIG. 4, the processing from Step 41 to Step 43 is the same as that from Step 31 to Step 33 of FIG. 3.

When the user posts review information of service of a restaurant B together with a card ID (Step 44), the review posting site transmits a restaurant ID of the restaurant B and the card ID to the moderation server 100 (Step 45).

The moderation server 100 searches the database for a corresponding restaurant ID with use of the received card ID as a key (Step 46). In the case where a corresponding restaurant ID is not found as a result of the search, an error notification is issued from the database (Step 47).

In this case, the moderation server 100 inquires, from the review posting site, restaurant information on nearby restaurants within an x-km radius (for example, 1-km radius) of the restaurant B (Step 48).

The review posting site returns information (restaurant ID etc.) of restaurants (for example, restaurants A, C, D, E, F) located within an x-km radius of the restaurant B to the moderation server 100 on the basis of positional information (latitude and longitude information) of each restaurant registered in advance (Step 49).

The moderation server 100 searches for the returned restaurant ID with use of the card ID transmitted together with the review information as a key (Step 50). Then, in the case where a restaurant ID of any of the restaurants is found, the moderation server 100 adds moderation information to the review information for publication, as in the case of Step 37 and Step 38 of FIG. 3 (Steps 51 and 52). In this case, for example, the fact that payment of any restaurant near the restaurant B has been recorded (or details of payment information thereof) is (are) displayed together with the review information of the restaurant B.

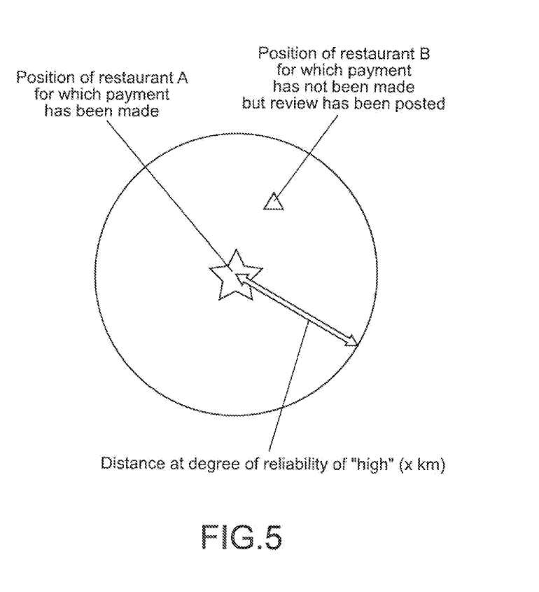

FIG. 5 is a diagram showing a relationship between a position of a restaurant and a degree of reliability of review information. As shown in FIG. 5, a range within an x km from the restaurant for which payment has been made is an activity range of the user (user's area) and set to be a range having a high degree of reliability of review information. Specifically, in the case where a restaurant (restaurant B described above) for which payment has not been made but its review has been posted is located within a range of an x km from a restaurant (for example, restaurant A) for which payment has been made, moderation information is added to the review information. This is because, as described above, a user who has posted a review to the restaurant B located within 1 km from the restaurant A for which payment has been made is likely to have visited the restaurant B in reality and made payment in cash, for example, instead of payment using an electronic money. Such processing improves not only the reliability of review information of a restaurant whose payment information is recorded, but also the reliability of review information of a restaurant near the former restaurant.

(Discount Processing After Moderation Processing)

In this embodiment, in the case where the content of a review is a complaint to the restaurant 300, the moderation server 100 can also give a discount to a user when the user visits the restaurant 300 at the next time. Hereinafter, three forms of the discount processing will be described. A discount may be given also in the case where the content of review information is not a complaint but positive one for the restaurant, as a matter of course.

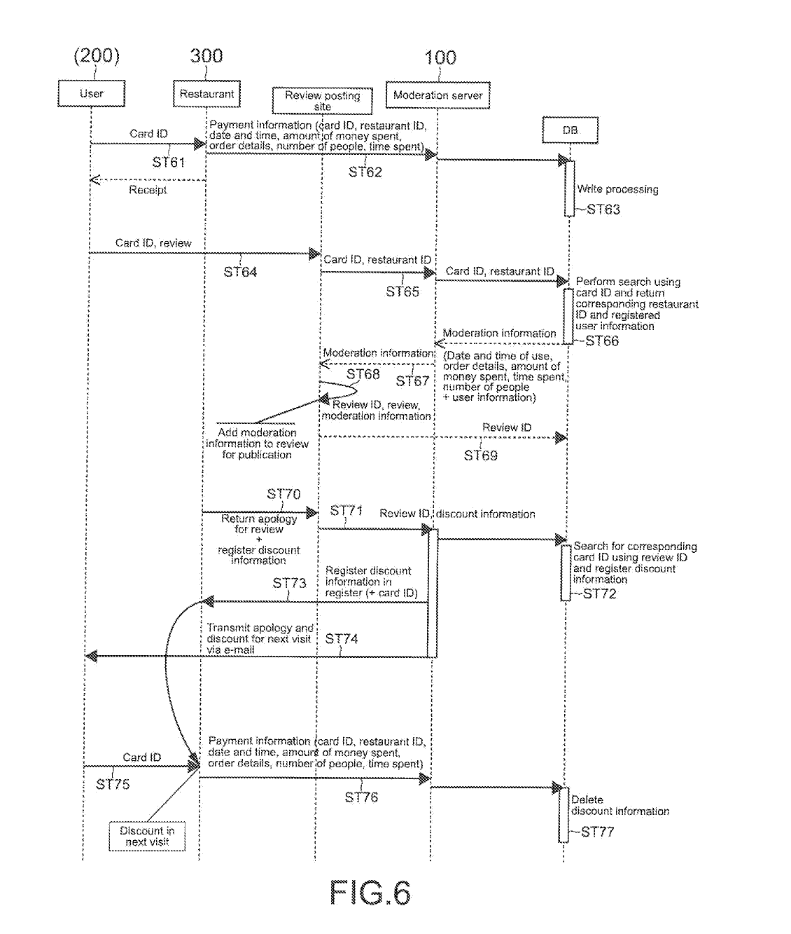

FIG. 6 is a sequence diagram showing a flow of the discount processing in the first form. In FIG. 6, processing of Step 61 to Step 68 is the same as that of Step 31 to Step 38 described above with reference to FIG. 3.

When the review information is released, the moderation server 100 registers a review ID for identifying the review information in the database (Step 69). In this case, the review ID and the restaurant ID and card ID described above are associated with each other.

When an administrator of the restaurant 300 views the review information and determines that the review information is a complaint, the administrator inputs apology information for the complaint and transmits the apology information (Step 70). At that time, discount information for allowing the user to receive a discount in the next visit is also transmitted.

Upon receiving the apology information and the discount information, the review posting site transmits the discount information and the review ID to the moderation server 100 (Step 71). The moderation server 100 searches for a corresponding card ID with use of the review ID as a key and registers the discount information in association with the card ID (Step 72).

Further, the review posting site transmits the discount information and the card ID associated with each other to the restaurant 300 and causes the POS register of the restaurant 300 to register the information (Step 73). At the same time, the review posting site transmits the received apology information to an e-mail address associated with the card ID (Step 74). At that time, a notification of a discount for the next visit is also transmitted.

Then, when the user visits the restaurant again and makes payment by an electronic money, since the discount information and the card ID are already registered in association with each other in the POS register, the card ID is read out and thus payment at the discount price is made (Step 75).

Upon completion of the payment, the payment information including the card ID is transmitted to the moderation server 100 (Step 76). The moderation server 100 deletes the discount information corresponding to the card ID included in the payment information from the database (Step 77).

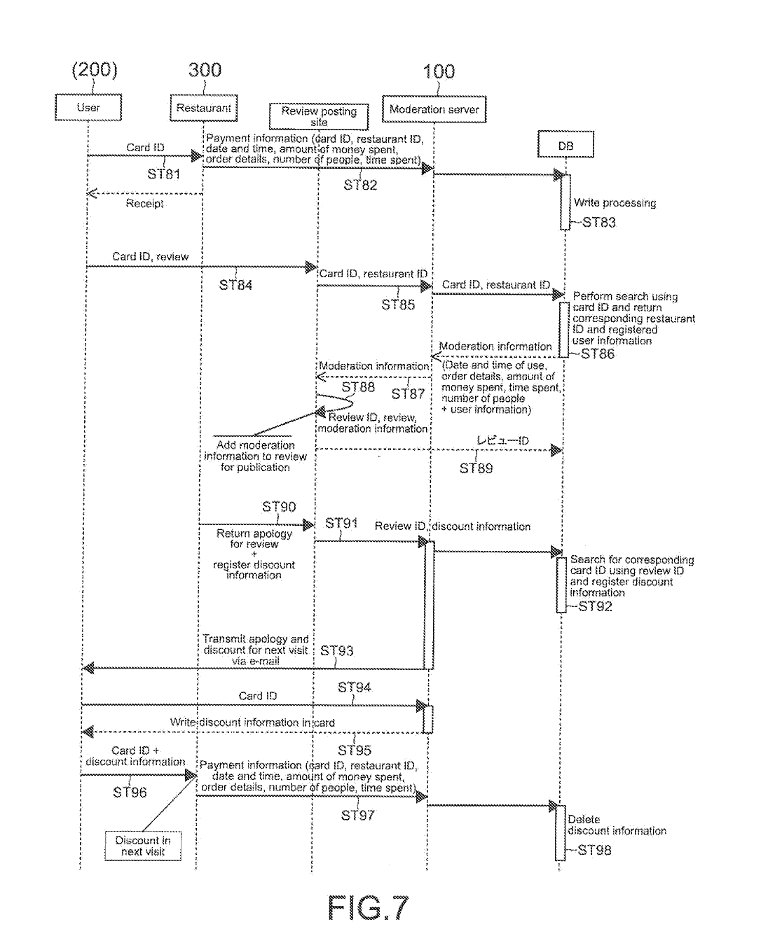

FIG. 7 is a sequence diagram showing a flow of the discount processing in the second form. In FIG. 7, processing of Step 81 to Step 93 is the same as that of Step 61 to Step 74 described above with reference to FIG. 6. However, the second form is different from the first form in that the discount information and the card ID are not registered in the POS register of the restaurant 300.

Upon receiving the e-mail, the user transmits the card ID from the user terminal 200 to the moderation server 100 (Step 94). The moderation server 100 returns the discount information registered in association with the card ID to the user terminal 200 (Step 95). Accordingly, the discount information is written in the IC chip of the user terminal 200.

Then, when the user visits the restaurant again, the discount information is read out together with the card ID with use of the reader/writer, and payment at the discount price is made (Step 96). The processing of deleting the discount information thereafter is the same as that of Step 76 and Step 77 described above with reference to FIG. 6 (Steps 97 and 98).

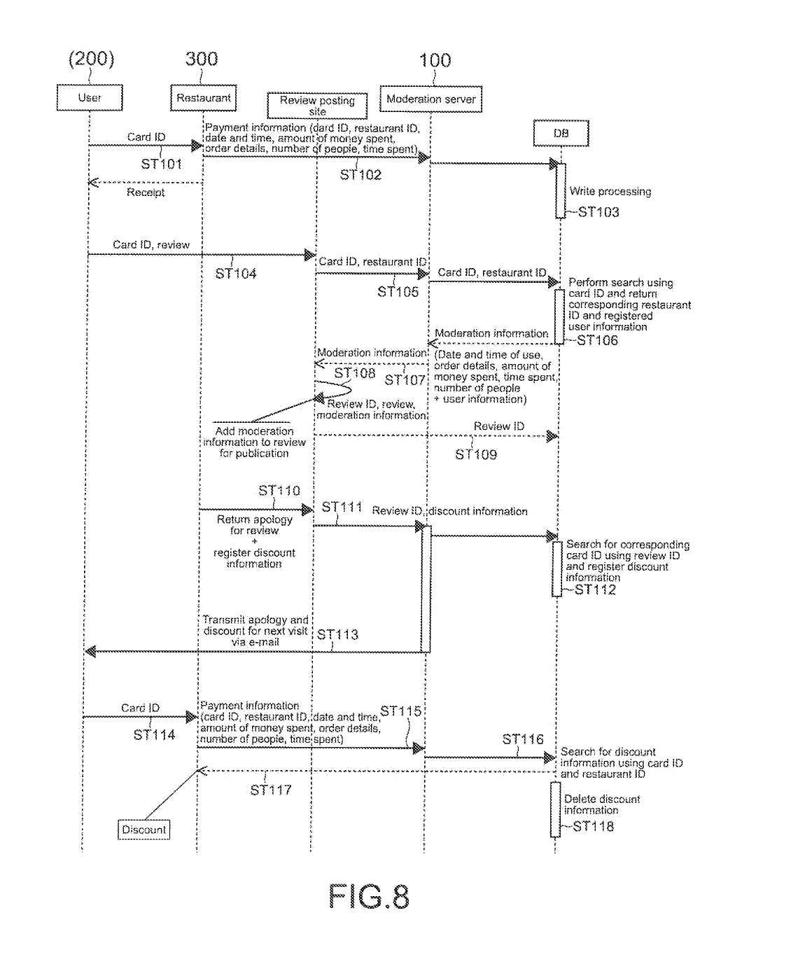

FIG. 8 is a sequence diagram showing a flow of the discount processing in the third form. In FIG. 8, processing of Step 101 to Step 113 is the same as that of Step 81 to Step 93 described above with reference to FIG. 7.

In the case where the user visits the restaurant again and makes payment (Step 114), the payment information including the card ID and the restaurant ID is transmitted to the moderation server 100 (Step 115). Upon receiving the payment information, the moderation server 100 searches for corresponding discount information with use of the card ID and the restaurant ID as keys (Step 116) and transmits the discount information to the restaurant 300 (Step 117). Accordingly, an amount of the payment in the POS register of the restaurant 300 is updated to an amount of the payment after discount. Further, after the moderation server 100 transmits the discount information, the moderation server 100 deletes the discount information (Step 118).

(Moderation Processing When Representative of Plurality of Users Make Payment for Received Service)

The case where one user makes payment has been described in the above. However, there may be a case where a plurality of users receive service and a representative of them makes payment all at one time. In such a case, in this embodiment, the moderation server 100 also performs the moderation processing not only on review information of the user who has made payment but also on review information of the other users who have received the service.

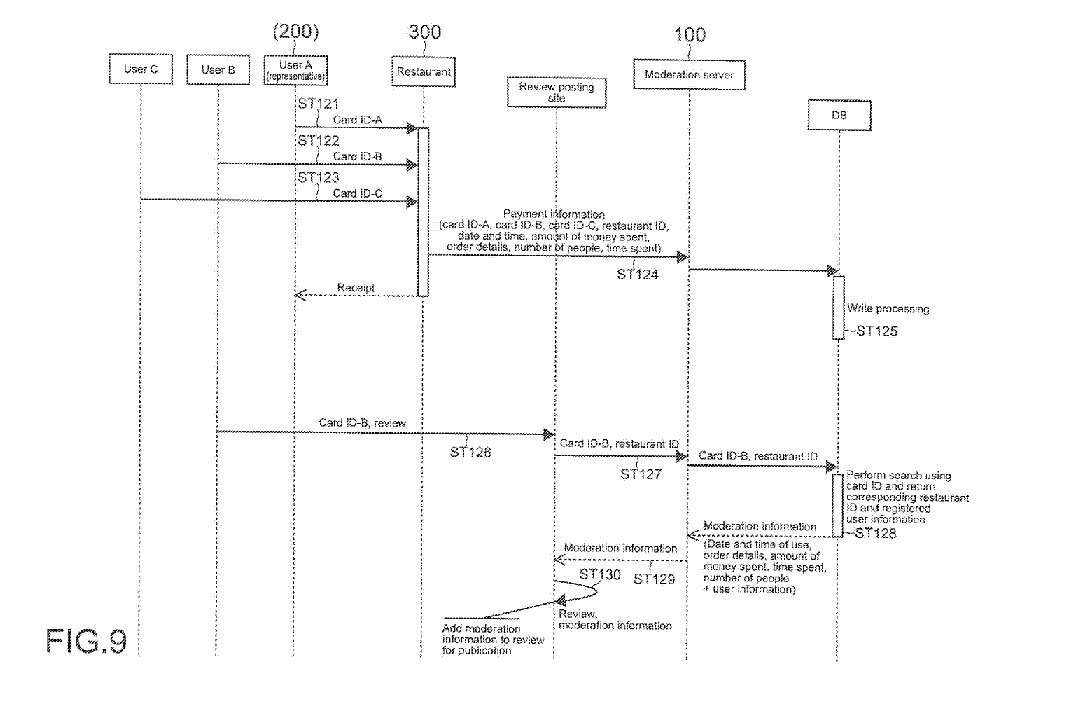

FIG. 9 is a sequence diagram showing a flow of the moderation processing in the case where a representative of a plurality of users makes payment for service provided to them. In FIG. 9, the case where three users A, B, and C receive service all together, and the user A as a representative makes payment and the user B posts a review will be described as an example.

In the case where the user A makes payment for the three users all at one time, a card ID-A is read out using the reader/writer from an IC card or a user terminal 200 of the user A (Step 121). At that time, a clerk requests the user B and the user C to pass their own IC cards or user terminals over the reader/writer, and then a card ID-B of the user B and a card ID-C of the user C are also read out (Steps 122 and 123).

The restaurant 300 transmits payment information including the card ID-A, the card ID-B, and the card ID-C to the moderation server 100 via the POS register (Step 124). The moderation server 100 writes the payment information in the database (Step 125).

Subsequently, the user B posts review information together with the card ID-B on the review posting site (Step 126). The review posting site transmits the card ID-B and a restaurant ID corresponding to the review information to the moderation server 100 (Step 127).

The moderation server 100 searches for a corresponding restaurant ID with use of the card ID-B (Step 128). As described above, since not only the card ID-A but also the card ID-B are registered in the database, moderation information is added to the review information for publication, as described with reference to FIG. 3 and the like (Steps 129 and 130).

Thus, the moderation server 100 can also add moderation information to review information from a user who has not made payment in reality, by registering a card ID of the user.

[Conclusion]

As described above, according to this embodiment, in the case where information on payment, by an electronic money, of a user who has posted a review exists, the moderation server 100 can set the information to be review information of the user who has visited a restaurant in reality and add moderation information thereto, with the result that a degree of reliability of the review information can be improved.

Further, even if the review information is information that criticizes the restaurant, this review information is information from the user who has visited the restaurant in reality and therefore it is distinguished from malicious slander/defamation. Then, the restaurant can cope with the complaint speedily and appropriately by, for is example, registering discount information, As a result, credibility of the restaurant can also be enhanced.

Further, since the restaurant does not grasp individual information of the user because payment information by an electronic money is used, anonymity of the user with respect to the restaurant is also ensured.

### Second Embodiment

Next, a second embodiment of the present disclosure will be described. In this embodiment, a point different from the first embodiment described above will be mainly described. The configuration of the first embodiment described above can be applied to parts that are not described in this embodiment.

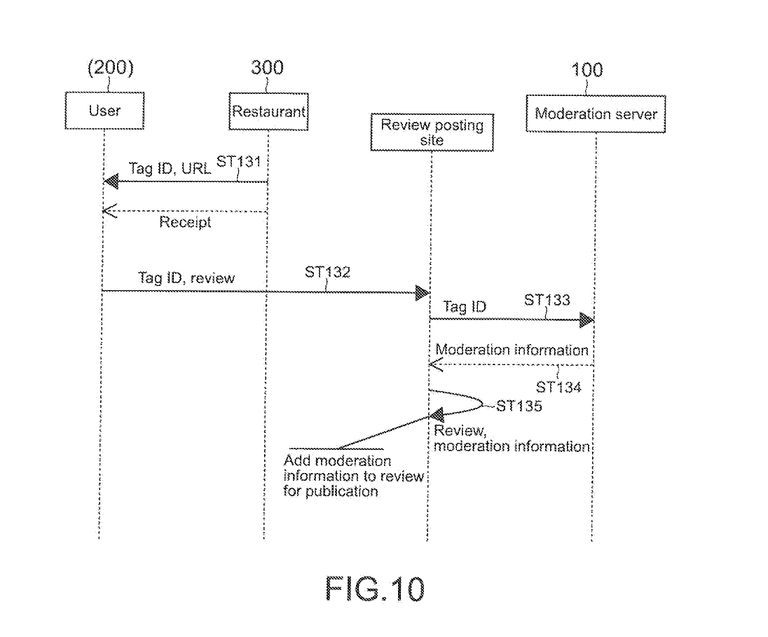

FIG. 10 is a sequence diagram showing a basic operation flow of a review posting system in this embodiment.

In this embodiment, in place of the payment information described above, a tag ID of an IC tag set in a restaurant is used for the moderation processing. The IC tag is one incorporated into media such as stickers and flyers put in the vicinity of the POS register of the restaurant 300, for example. The IC tag can communicate with the user terminal 200 conforming to a wireless communication standard such as NFC (Near Field Communication). In the IC tag, a tag ID for uniquely identifying the IC tag and a URI, of the review posting site are stored.

As shown in FIG. 10, a user uses the user terminal 200 to read out a tag ID and a URL of the review posting site from an IC tag at a time of payment (Step 131).

The user uses the URI, to post review information on the review posting site (Step 132). At that time, the tag ID is also transmitted.

The tag ID is transmitted to the moderation server 100 via the review posting site (Step 133). Upon reception of the tag ID, the moderation server 100 generates moderation information with respect to the review information (Step 134) and adds the moderation information to the review information for publication (Step 135).

In this embodiment, payment information is not transmitted to the moderation server 100. Therefore, the moderation information in this embodiment is, for example, character information, an icon, and the like indicating that a user who has posted the review information has visited the restaurant in reality.

As described above, in this embodiment, the tag ID functions as use information indicating that the user has used the restaurant. Then, in the case where a tag ID corresponding to review information is registered in the moderation server 100, the user who has posted the review information is determined to be a user who has visited the restaurant 300 in reality, and accordingly moderation information is added to the review information for publication.

In this embodiment, payment information is not transmitted to the moderation server 100, but information except for the card ID described above may be transmitted. In this case, the same processing as that of the first embodiment described above may be executed as additional processing of the moderation information.

### Third Embodiment

Next, a third embodiment of the present disclosure will be described. In this embodiment, a point different from the first embodiment described above will be mainly described. The configuration of the first embodiment described above can be applied to parts that are not described in this embodiment.

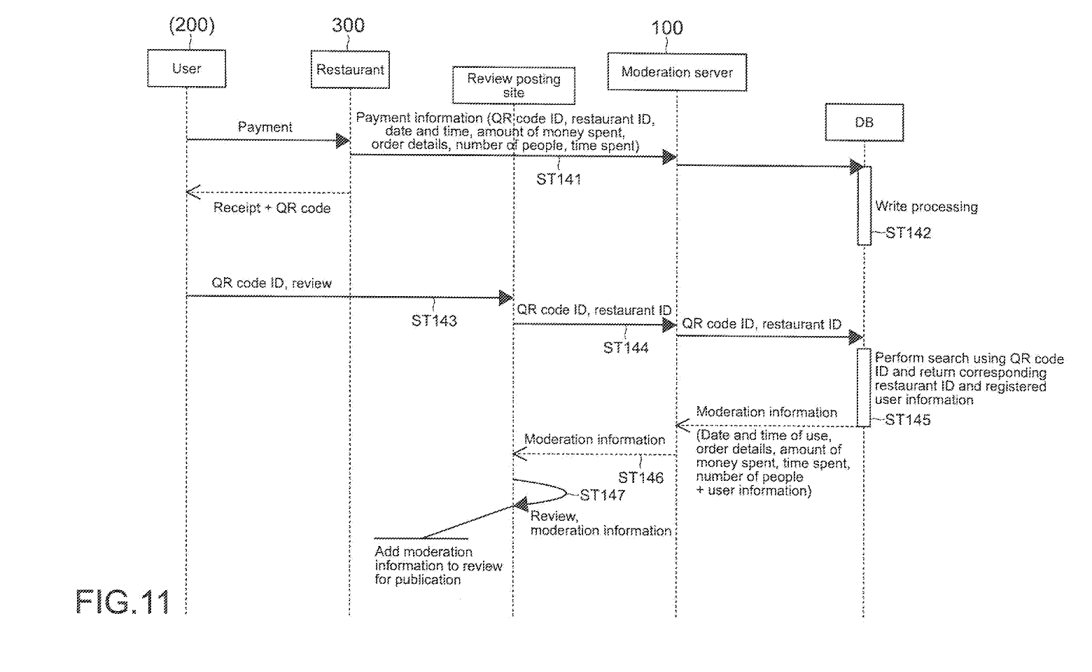

FIG. 11 is a sequence diagram showing a basic operation flow of a review posting system in the third embodiment of the present disclosure.

In this embodiment, in place of the payment information or tag ID described above, a QR (quick response) code printed on a receipt that is handed to the user in payment is used for the moderation processing. In the QR code, a QR code ID for uniquely identifying the QR code and a URL of the review posting site are stored.

As shown in FIG. 11, when a user makes payment in the restaurant 300, payment information including a QR code ID is transmitted to the moderation server 100 (Step 141). The moderation server 100 registers the payment information in the database (Step 142).

Upon completion of the payment, a clerk issues a receipt with a QR code. The user reads out the QR code with use of a camera incorporated into a user terminal 200.

The user uses the URL to post review information on the review posting site (Step 143). At that time, the QR code ID is also transmitted.

After that, as described in the first embodiment with reference to FIG. 3, the QR code ID is handled in the same manner as a card ID, and moderation information is added to the review information for publication (Steps 144 to 147).

As described above, in this embodiment, the QR code ID functions as use information indicating that the user has used the restaurant. Then, in the case where a QR code ID corresponding to review information is registered in the moderation server 100, the user who has posted the review information is determined to be a user who has visited the restaurant 300 in reality, and accordingly moderation information is added to the review information for publication.

### Other Modified Examples

The present disclosure is not limited to the embodiments described above and can be variously modified without departing from the gist of the present disclosure.

In the embodiments described above, with the presence of use information such as a card ID, a tag ID, and a QR code ID, moderation information is added to review information that has been posted by a user. However, in the case where use information does not exist in the first place, the review posting site may be set such that posting of review information is not accepted. In this case, only review information from users who have visited the restaurant in reality (or highly likely to have visited the restaurant) is released, with the result that a degree of reliability of the review posting site itself is improved.

In the embodiments described above, the moderation processing in the case where a user has used a restaurant has been described. However, use information on all facilities including shops such as a retail store, a karaoke bar, a laundry, and a hair salon, a hospital, and a hotel that provide users with some service may be used in the moderation processing without being limited to the restaurant.

Further, in the first embodiment described above, in the case where use information of a restaurant located within a predetermined distance from the restaurant for which the user has posted review information is registered, moderation information is added. However, for example, if even a piece of use information on all facilities located within a predetermined distance from the restaurant exists, though not limited to the restaurant, moderation information may be added. In this case, the use information may not be payment information. For example, if a user terminal has a GPS (Global Positioning System) function, the moderation server 100 receives positional information acquired by UPS, for example periodically, from the user terminal 200, and the positional information falls within the predetermined distance, moderation information may be added.

In the first embodiment described above, the description has been given on the assumption that one card ID exists for each user. However, it is also conceived that a user has a plurality of cards or user terminals that conform to electronic money. In this case, the moderation server 100 performs the same processing as that of name identification and manages a plurality of card Ms in association with one another, with the result that moderation processing can be performed even if the user uses any of the card IDs.

In the embodiments described above, in the case where a period of time from a date and time of payment to a date and time of posting of review information is a predetermined period of time or more, the moderation server 100 may not add moderation information to the review information even if the review information is a target to which moderation information is added. This is because review information after a considerable period of time has elapsed since the visit to a restaurant may not necessarily reflect the current state of the restaurant. Further, when this processing and the above-mentioned registration processing of discount information are combined with each other, incentives to post review information are created for a user immediately after the visit of a restaurant, with the result that the restaurant can cope with reviews speedily.

The moderation information in the embodiments described above is applicable to recommendation processing. For example, a degree of reliability with respect to a recommendation (advertisement) using collaborative filtering, like “Those who give high estimation to this restaurant also give it to the following restaurants.”, can be further improved.

In the embodiments described above, the example in which the present disclosure is applied to a server including hardware as a computer generally used has been described. However, the present disclosure is applicable to any other information processing apparatuses in the same manner.

### [Others]

The present disclosure can also take the following configurations.

(1) An information processing apparatus, including:
a communication unit capable of receiving first use information indicating that a first user has used a first service-providing facility and first feedback information on service of the first service-providing facility, the first feedback information being input in a user terminal and associated with the first use information;
a storage capable of storing the received first use information and first feedback information in association with each other; and
a controller capable of executing predetermined information processing for indicating that the stored first feedback information has high reliability.

(2) The information processing apparatus according to Item (1), in which
the communication unit is capable of receiving second feedback information on the service, which is not associated with the first use information,
the storage is capable of storing the received second feedback information, and
the controller is capable of processing the first feedback information so as to be distinguishable from the second feedback information.

(3) The information processing apparatus according to Item (1) or (2), in which
the first use information is payment information that is transmitted from the first service-providing facility and includes first electronic money identification information for identifying an electronic money used by the first user for payment in the first service-providing facility,
the communication unit executes
   first communication processing of receiving the payment information, and
   second communication processing of receiving the first feedback information and second electronic money identification information for identifying an electronic money used by a user who has input the first feedback information, and
the controller executes the predetermined information processing in a case where the first electronic money identification information included in the payment information received by the first communication processing coincides with the second electronic money identification information received by the second communication processing.

(4) The information processing apparatus according to Item (1) or (2), in which
the user terminal reads out, from an IC tag set in the first service-providing facility, a tag ID for identifying the IC tag and transmits the first feedback information to the information processing apparatus together with the tag ID, and
the communication unit receives the tag ID as the first use information.

(5) The information processing apparatus according to any one of Items (1) to (4), in which
the storage stores positional information items of a plurality of service-providing facilities including the first service-providing facility,
the communication unit receives second feedback information on service of a second service-providing facility that is different from the first service-providing facility, and
the controller executes, in a case of determining based on the positional information items that a distance between the first service-providing facility and the second service-providing facility is within a predetermined range, predetermined information processing for indicating that the second feedback information has high reliability.

(6) The information processing apparatus according to any one of Items (1) to (5), in which
the communication unit receives, from the first service-providing facility, reply information with respect to the first feedback, information and discount information allowing a discount to be given at a time of payment for service that can be provided later to the first user in the first service-providing facility,
the storage stores the received reply information and discount information, and
the controller controls the communication unit to transmit the reply information and information indicating presence of the discount information to the user terminal and to transmit the discount information to one of the user terminal and the first service-providing facility.

(7) The information processing apparatus according to Item (3), in which
the payment information includes third electronic money identification information for identifying an electronic money of another user provided with the service in the first service-providing facility, together with the first user who has made the payment, and
the controller executes the predetermined information processing also in a case where the third electronic money identification information coincides with the second electronic money identification information

(8) The information processing apparatus according to any one of Items (1) to (7), in which
the first use information includes information indicating a date and time of usage at which the first user has used the first service-providing facility, and
the controller executes the predetermined information processing in a case where a period of time from the date and time of usage to a date and time at which the first feedback information has been received is within a predetermined period of time.

The present application contains subject matter related to that disclosed in Japanese Priority Patent Application JP 2011-095814 filed in the Japan Patent Office on Apr. 22, 2011, the entire content of which is hereby incorporated by reference.

### REFERENCE SIGNS LIST

11 CPU

18 storage

19 communication unit

50 internet

100 moderation server

200 user terminal

300 restaurant

1. An information processing apparatus, comprising
a communication unit capable of receiving first use information indicating that a first user has used a first service-providing facility and first feedback information on service of the first service-providing facility, the first feedback information being input in a user terminal and associated with the first use information;
a storage capable of storing the received first use information and first feedback information in association with each other; and
a controller capable of executing predetermined information processing for indicating that the stored first feedback information has high reliability,

2. The information processing apparatus according to claim 1, wherein
the communication unit is capable of receiving second feedback information on the service, which is not associated with the first use information,
the storage is capable of storing the received second feedback information, and
the controller is capable of processing the first feedback information so as to be distinguishable from the second feedback information,

3. The information processing apparatus according to claim 1, wherein
the first use information is payment information that is transmitted from the first service-providing facility and includes first electronic money identification information for identifying an electronic money used by the first user for payment in the first service-providing facility,
the communication unit executes
first communication processing of receiving the payment information, and
second communication processing of receiving the first feedback information and second electronic money identification information for identifying an electronic money used by a user who has input the first feedback information, and
the controller executes the predetermined information processing in a case where the first electronic money identification information included in the payment information received by the first communication processing coincides with the second electronic money identification information received by the second communication processing.

4. The information processing apparatus according to claim 1, wherein
the user terminal reads out, from an IC tag set in the first service-providing facility, a tag ID for identifying the IC tag and transmits the first feedback information to the information processing apparatus together with the tag ID, and the communication unit receives the tag ID as the first use information.

5. The information processing apparatus according to claim 1, wherein
the storage stores positional information items of a plurality of service-providing facilities including the first service-providing facility,
the communication unit receives second feedback information on service of a second service-providing facility that is different from the first service-providing facility, and
the controller executes, in a case of determining based on the positional information items that a distance between the first service-providing facility and the second service-providing facility is within a predetermined range, predetermined information processing for indicating that the second feedback information has high reliability.

6. The information processing apparatus according to claim 1, wherein
the communication unit receives, from the first service-providing facility, reply information with respect to the first feedback information and discount information allowing a discount to be given at a time of payment for service that can be provided later to the first user in the first service-providing facility,
the storage stores the received reply information and discount information, and
the controller controls the communication unit to transmit the reply information and information indicating presence of the discount information to the user terminal and to transmit the discount information to one of the user terminal and the first service-providing facility.

7. The information processing apparatus according to claim 3, wherein
the payment information includes third electronic, money identification information for identifying an electronic money of another user provided with the service in the first service-providing facility, together with the first user who has made the payment, and
the controller executes the predetermined information processing also in a case where the third electronic money identification information coincides with the second electronic money identification information.

8. The information processing apparatus according to claim 1, wherein
the first use information includes information indicating a date and time of usage at which the first user has used the first service-providing facility, and
the controller executes the predetermined information processing in a case where a period of time from the date and time of usage to a date and time at which the first feedback information has been received is within a predetermined period of time.

9. An information processing method, comprising:
receiving use information indicating that a user has used a service-providing facility and feedback information on service of the service-providing facility, the feedback information being input in a user terminal and associated with the use information;
storing the received use information and feedback information in association with each other; and
executing predetermined information processing for indicating that the stored feedback information has high reliability.

10. A program causing an information processing apparatus to execute the steps of:
receiving use information indicating that a user has used a service-providing facility and feedback information on service of the service-providing facility, the feedback information being input in a user terminal and associated with the use information;
storing the received use information and feedback information in association with each other; and
executing predetermined information processing for indicating that the stored feedback information has high reliability.
